(19) United States
(12) Patent Application Publication
(10) Pub. No.: US 2007/0095552 A1
(43) Pub. Date: May 3, 2007

(54) Protective shield for conductor products

(75) Inventors: G. Christopher Thierolf, Abington, PA (US); Cassie Malloy, Blue Bell, PA (US); Michael Piotrowski, Plymouth Meeting, PA (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal-Mogul World Wide, Inc.

(21) Appl. No.: 11/393,222

(22) Filed: Mar. 30, 2006

Related U.S. Application Data
(60) Provisional application No. 60/730,925, filed on Oct. 27, 2005.

(51) Int. Cl. H01B 11/06

(52) U.S. Cl. 174/36

(57) ABSTRACT

The invention provides a protective shield for an elongate conductor. The protective shield includes a textile sleeve of interlaced yarns operable to surround a conductor product. The protective shield also includes at least one drain wire laid-in between the interlaced yarns. The at least one drain wire extends longitudinally along the textile sleeve for protecting the conductor product from electromagnetic interference.

### CROSS-REFERENCE TO RELATED APPLICATIONS

This application claims the benefit of United States Provisional Patent Application Ser. No. 60/730,925 for a FLAT WIRE SLEEVING, filed on Oct. 27, 2005, which is hereby incorporated by reference in its entirety.

### BACKGROUND OF THE INVENTION

1. Field of the Invention

This invention relates to products for protecting electrical conductor products from electromagnetic (“EMI”) and radio frequency interference (“RFI”).

2. Related Art

EMI and RFI have the potential of preventing the proper functioning of electronic components caused by inductive coupling between electrical conductors carrying currents which vary over time or which are subject to the propagation of electromagnetic waves.

For example, electrical current in conductors associated with the ignition system of a motor vehicle may interfere with electronic modules controlling the engine causing malfunctions causing potentially serious consequences.

The adverse effects of EMI and RFI are effectively eliminated by proper shielding and grounding of EMI sensitive components. For example, wires carrying control signals which may be subject to unwanted induced interference may be shielded by using a protective sleeve as described in U.S. Pat. No. 4,684,762 to Gladfelter, wherein the sleeve is formed of electrically conductive and non-conductive interlaced yarns (woven, braided or knitted), the conductive yarns being grounded via a drain wire interlaced with the yarns during manufacture of the sleeve, the drain wire being in electrical contact with the conductive yarns.

### SUMMARY OF THE INVENTION

The invention provides a protective shield for an elongate conductor. The protective shield includes a textile sleeve of interlaced yarns operable to surround a conductor product. The protective shield also includes at least one drain wire laid-in between the interlaced yarns. The at least one drain wire extends longitudinally along the textile sleeve for protecting the conductor product from electromagnetic interference.

### BRIEF DESCRIPTION OF THE DRAWINGS

Advantages of the present invention will become more readily appreciated when considered in connection with the following detailed description and appended drawings, wherein:

FIG. 1 is a perspective view of an encapsulated 10 flat wire component showing the preferred positioning of a drain wire in relation to the component;

FIG. 2 is a view showing the flat wire component with laid-in drain wire in an overbraided sleeve formed according to the present invention; and

FIG. 3 shows in schematic form a preferred process of manufacture of the preferred form of the present invention.

### DETAILED DESCRIPTION OF THE PREFERRED EMBODIMENT

The exemplary embodiment of the invention provides an RFI/EMI protective textile shield which is comprised of braided, woven or knitted yarn operable to surround a conductor product such as flat flexible cable substrates and flat wire products. Such flat conductors can be encapsulated within a thin, flexible polymeric substrate. Flat conductors are used in the automotive industry for wire harness applications, navigation systems, on-board entertainment systems and other electronic equipment. The use of a protective shield, such as taught by the exemplary embodiment of the invention, reduces the likelihood that EMI/RFI will compromise the operation of conductor products such as flat or round conductors.

The protective shield of the exemplary embodiment of the invention includes a sleeve operable to surround a flat conductor product and formed from relatively flexible conductive yam or monofilament typically formed of polyester, polypropylene, nylon or carbon fiber, etc., typically having a denier of between about 100 and 1200 or diameter 0.003″- 0.009″. The yarn can be non-electrically conductive or electrically conductive. If increased electrical conductivity is desired (i.e., lower surface resistivity), a conductive coating of carbon black, silver, nickel/copper or other metallic particle mixed with liquid polymer, elastomer or acrylic emulsion can be applied over the sleeve. Even if the yarn per se is non-conductive, or if it is desired to interlace non-conductive yarns and conductive yarns together as, for example, where properties of thermal, abrasion or moisture protection are also desired, the overbraided sleeve can be coated with a liquid coating material and thereafter cured and set. This same coating can also provide dielectric properties to electrically shield the textile from contact with nearby electrically conductive components (very much like PVC or Teflon jacketed insulation on a typical round wire, or thermoplastic covering on aforementioned elongated flat flexible cable. The coated textile structure encapsulates the conductor product.

At least one drain wire is laid-in in a direction extending lengthwise of the sleeve. The invention can be practiced with more than one drain wire. The drain wire can be disposed along one side edge of the sleeve or another location within the sleeve. The drain wire can be displaced from the conductors such that the drain wire is in intimate contact with the yarns and with the conductive coating to provide a path to ground when properly terminated. A textile overlayer provides a flexible protective covering that is resistant to the cracking and discontinuity. EMI/RFI protectors for flat conductor products, such as electrically conductive polymers, inks or paints, can be prone to cracking and discontinuity.

The invention, including the exemplary embodiment, can be amenable to automated manufacturing techniques. One aspect of the exemplary embodiment is the feature of positioning the drain wire to one side of the perimeter of the flat wire sleeve or another location laterally offset from the flat conductors so as to facilitate flat wire breakouts and drain wire continuity and avoidance of surface-mounted electrical components and circuits on the substrate.

In a flat, flexible cable product of the type described herein, up to ten or more flat conductors may be encapsulated in side-by-side relationship in a thin substrate. The substrates may also contain low profile circuit components. Each conductor may be subject to breakout at any point along the length of the substrate, and this is accomplished by instruments positioned during the manufacturing process adjacent the top or bottom of the substrate in order to selectively ablate portions of the top or bottom surface to expose a selected conductor and make an electrical connection with a branch line or with the drain wire. Varying the position of the drain wire allows freedom of access of the instrument to conductors underlying or over the upper and lower surfaces of a substrate.

Preferably, the drain wire comprises stranded copper. In certain applications, the drain wire may be electrically connected to selected conductors or circuit components within the flat wire substrate by use of suitable connectors and/or is connected directly to ground.

The overbraided sleeve is highly flexible, facilitating installation and provides mechanical protection for the substrate, as well as EMI and RFI protection.

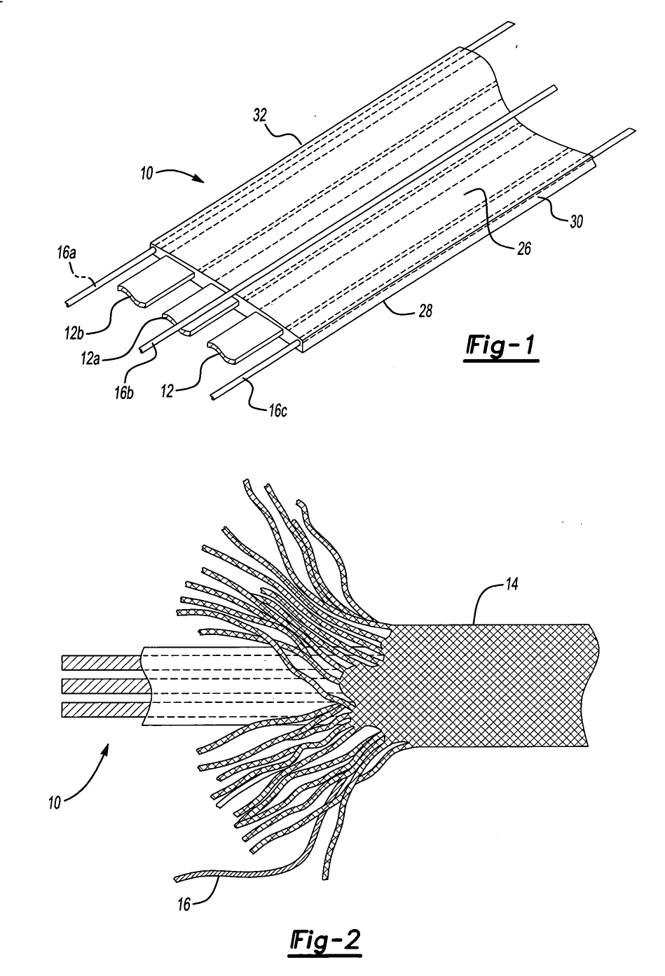

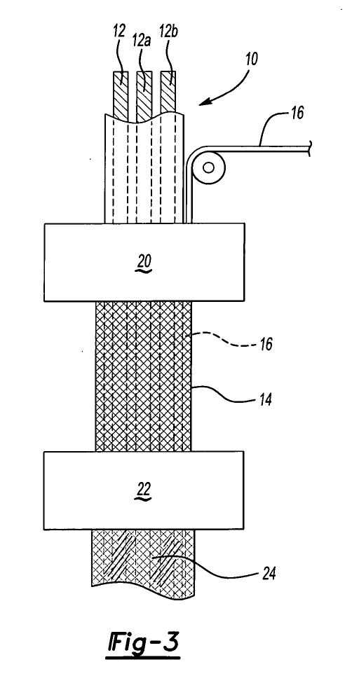

As illustrated in FIG. 1, a typical form of flat wire component or product 10 comprises a plurality of flat wires 12, 12a, 12b encapsulated within a thermoplastic resin, such as polyurethane, to form a low profile, lightweight and flexible wiring component, also known as a flat flexible cable or “FFC.” By way of example, such components typically have a thickness of about 0.45 mm to about 0.55 mm and a width which is variable depending upon the number of conductors encapsulated but, in a typical case, being about 19 mm. Such products are lightweight and extremely flexible and lend themselves well to being installed in situations where they must fit into confined spaces and navigate sharp turns as, for example, when installed in an automobile in a situation where they must fit between the headliner and the roof of a typical automobile and may be required to follow a tortuous path.

A section of the flat wire component 10 of FIG. 1 is shown in FIG. 2 which further illustrates the provision of a sleeve 14 which is provided for the shielding of the electrical conductors 12, 12a, 12b from radio frequency and electromagnetic interference. In the preferred embodiment, the sleeve 14 is braided and is comprised of about 30% to about 90% of conductive filamentary members by weight. Suitable conductive yarns are known in the art. The yarns include conductive fibers made from stainless steel, carbon or a conductive polymer or by providing non-conductive fibers or yarns that are plated, coated, twisted or impregnated with a conductive material. Various yarns and fibers, as well as coatings therefore, are disclosed in U.S. Pat. No. 4,684,762 which is hereby incorporated by reference. Although it is preferred that the sleeve be a braided sleeve, and most preferably that it be applied to the substrate by an overbraiding process so that it increases the cross section of the substrate by a minimal amount, the sleeve 14 can be formed by knitting or by weaving.

As can be seen in FIG. 2, and also by reference to FIG. 1, the invention further involves the provision of a drain wire 16. The drain wire 16 is preferably laid-in during the braiding process and held in place between the crossing braid yarns. Also, the drain wire 16 is preferably positioned adjacent one side edge of the elongated substrate. FIG. 1 shows an alternative embodiment of the invention wherein the a plurality of drain wires 16a, 16b, 16c, shown in phantom, are arranged as at various positions relative to the conductors 12, 12a, 12b of the FFC 10. The drain wire 16b is disposed substantially centered with respect to the width of the FFC 10.

In alternative embodiments of the invention, the drain wire 16 can be positioned above or below the FFC 10. In some operating environments, it may not be desirable to position the drain wire 16 directly over one of the conductors 12, 12a, 12b or in position to interfere with circuits disposed on the FFC 10, such as taught in U.S. Published Application 20050023031, which is hereby incorporated by reference. In exemplary embodiments of the invention for such operating environments, the drain wire 16 can be spaced from the FFC 10. In other words, the drain wire 16 can be below an exposed surface of the sleeve 14 or nested within the textile structure of the sleeve 14. The drain wire 16 can be formed from individual copper strands twisted together and can be as flexible as the FFC 10.

In manufacturing an exemplary embodiment of the invention, the flat wire substrate or FFC 10 and the drain wire 16 are directed to the braider 20 from respective supply spools (not shown). The braider 20 forms the sleeve 14, relatively tightly overbraiding the FFC 10 with the drain wire 16 substantially locked in place, such as along one of the side edges of the FFC 10. Following braiding, the product formed from the FFC 10 and the sleeve 14 and the drain wire 16 can be fed directly to a coating applicator 22 having a heater or other suitable means for curing a coating. FIG. 2 shows a portion of the sleeve 14 having a coating 24.

The coating 24 can include conductive materials that enhance the shielding capabilities of the sleeve 14. One possible coating 24 can be an acrylic emulsion to reduce the likelihood of end fray and to enhance the stiffness of the yarns. Conductivity may be imparted to the coating 24 by the addition of particles of conductive material such as carbon black, silver, nickel/copper or the like. The sleeve and/or the coating 24 can be removed to allow interconnection between one of the conductors 12, 12a, lb, such as a grounded conductor, and the drain wire 16.

Electrical connection may be made between the selected circuit component and drain wire 16 or with an electrical circuit spaced from the position of the sleeve 14, as required.

In summary, the exemplary embodiment of the invention provides a protective shield for a low profile, elongated, flexible, one or more conductor product 10. The conductor product 10 has parallel top and bottom planar surfaces 26, 28 and relatively narrow side edges 30, 32. The exemplary shielding product includes a textile sleeve 14 of interlaced yarns that are at least partially electrical conductive. The sleeve 14 is flexible to conform to curvatures in the path followed by the conductor product 10. The protective shield also includes a drain wire 16 positioned in contact with the interlaced yarns and adjacent to one side edge 30, 32 or conductor 12, 12a, 12b of the conductor product 10. The drain wire 16 extends lengthwise along the conductor product 10 and sleeve 14.

The exemplary sleeve 14 is overbraided on the conductor product 10 so that the yarns engage the surfaces 26, 28, 30, 32 of the conductor product 10. The sleeve 14 supports the drain wire 16, the drain wire being laid-in between the yarns of the braid so as to maintain the drain wire 16 in a desired space relation to the side 30 or 32 or to the conductor 12 or 12a or 12b of the conductor product 10. The exemplary sleeve 14 is coated with a coating 24 of flexible, electrically conductive material.

Obviously, many modifications and variations of the present invention are possible in light of the above teachings. It is, therefore, to be understood that within the scope of the appended claims, the invention may be practiced otherwise than as specifically described.

1. A protective shield for an elongate conductor comprising:
a textile sleeve of interlaced yarns operable to surround a conductor product;
at least one drain wire laid-in between said interlaced yarns and extending longitudinally along said textile sleeve for protecting the conductor product from at least one of radio frequency interference and electromagnetic interference; and
a conductive coating covering said textile sleeve and in intimate contact with said at least one drain wire.

2. The protective shield of claim 1 wherein said textile sleeve is further defined as being woven.

3. The protective shield of claim 1 wherein said textile sleeve is further defined as being knitted.

4. The protective shield of claim 1 wherein said textile sleeve is further defined as being braided.

5. The protective shield of claim 1 wherein said interlaced yarns are further defined as including between 30% and 90% conductive yarns by weight.

6. The protective shield of claim 1 wherein said at least one drain wire is nested within said interlaced yarns of said textile sleeve.

7. (canceled)

8. The protective shield of claim 1 wherein said conductive coating is further defined as an acrylic emulsion.

9. The protective shield of claim 1 wherein said conductive coating further comprises:
particles of conductive material suspended in a liquid flexible carrier medium.

10. The protective shield of claim 9 wherein said particles are selected from the group comprising carbon black, silver, nickel and copper.

11. A method of forming a protective shield comprising the step of:
surrounding a conductor product with a textile sleeve of interlaced yarns;
laying-in at least one drain wire between the interlaced yarns extending longitudinally along the textile sleeve for protecting the conductor product from at least one of radio frequency interference and electromagnetic interference; and
covering the textile sleeve with a conductive coating also in intimate contact with the at least one drain wire.

12. The method of claim 11 wherein said surrounding step includes the step of:
braiding the yarns around the conductor product to form the textile sleeve.

13. The method of claim 13 wherein said laying-in step is further defined as occurring during said braiding step.

14. The method of claim 11 wherein said laying-in step includes the step of:
disposing the at least one drain wire along an edge of the conductor product.

15. The method of claim 11 wherein said laying-in step includes the step of:
disposing the at least one drain wire below an exposed surface of the sleeve and above an outer surface of the conductor product.

16. The method of claim 15 wherein the disposing step is further defined as:
nesting the at least one drain wire within a textile structure of the sleeve.

17. The method of claim 11 further comprising the step of:
coating the sleeve with conductive materials after said surrounding step.

18. (canceled)

19. The protective shield of claim 1 wherein said textile sleeve and said drain wire and said conductive coating are further defined as flexible together for navigating sharp turns.
